(19) United States
(12) Patent Application Publication
(10) Pub. No.: US 2013/0234065 A1
(43) Pub. Date: Sep. 12, 2013

(54) POLYMER DISPERSED LIQUID CRYSTAL COMPOSITION FOR LOWERING DRIVING VOLTAGE OF POLYMER DISPERSED LIQUID CRYSTAL DISPLAY DEVICE AND MANUFACTURING METHOD THEREOF

(71) Applicants: WINTEK (CHINA) TECHNOLOGY LTD., Dongguan City (CN); WINTEK CORPORATION, Taichung City (TW)

(72) Inventors: Kuan-Hsien Wu, Changhua County (TW); Hsien-Wei Chiang, Taipei City (TW); Chih-Yuan Wang, Taichung City (TW)

(73) Assignees: WINTEK CORPORATION, Taichung City (TW); WINTEK (CHINA) TECHNOLOGY LTD., Dongguan City (CN)

(21) Appl. No.: 13/773,602

(22) Filed: Feb. 21, 2013

(30) Foreign Application Priority Data
Mar. 8, 2012 (TW) 101107837

(51) Int. Cl. C09K 19/02

(52) U.S. Cl. CPC C09K 19/02
USPC 252/299.01

(57) ABSTRACT

A polymer dispersed liquid crystal composition for lowering driving voltage of a polymer dispersed liquid crystal display device includes a polymer material, a plurality of liquid crystal molecules, and a plurality of non-conducting particles. The liquid crystal molecules are dispersed in the polymer material, and the liquid crystal molecules are disposed in a plurality of liquid crystal encapsulators formed by the polymer material. The non-conducting particles are dispersed in the polymer material.

### BACKGROUND OF THE INVENTION

1. Field of the Invention

The present invention relates to a polymer dispersed liquid crystal composition for lowering driving voltage of a polymer dispersed liquid crystal display device and a manufacturing method thereof, and more particularly, to a polymer dispersed liquid crystal composition including a polymer material partially replaced by non-conducting particles for lowering driving voltage of a polymer dispersed liquid crystal display device and a manufacturing method thereof.

2. Description of the Prior Art

A conventional operating principle of a polymer dispersed liquid crystal is through controlling the birefringence of liquid crystal molecules and the refraction ratio difference between a polymer material and the liquid crystal molecules to generate two different states such as a transmitting state and a scattering state. Please refer to FIG. 1 and FIG. 2. FIG. 1 and FIG. 2 are schematic diagrams illustrating a conventional polymer dispersed liquid crystal. FIG. 1 is a diagram illustrating the condition of the polymer dispersed liquid crystal when no voltage is applied to the polymer dispersed liquid crystal. FIG. 2 illustrates the condition of the polymer dispersed liquid crystal when voltage is applied to the polymer dispersed liquid crystal. As shown in FIG. 1 and FIG. 2, the conventional polymer dispersed liquid crystal 100 includes a polymer material 111 and a plurality of liquid crystal molecules 120. The liquid crystal molecules 120 are dispersed in a plurality of liquid crystal encapsulators 112 formed by the polymer material 111. The polymer material 111 has a refraction ratio n₁, and each of the liquid crystal molecules 120 has a parallel axis refraction ratio n₂ and a vertical axis refraction ratio n₃. Generally, the parallel axis refraction ratio n₂ of the liquid crystal molecules 120 is preferably equal to the refraction ratio n₁ of the polymer material 111. Accordingly, a presenting refraction ratio of each of the liquid crystal molecules 120 may be similar to the refraction ratio n₁ of polymer material 111 when the liquid crystal molecules 120 are arranged in a direction by voltage applied (as shown in FIG. 2), and it helps to present a better transparent condition. In other words, when voltage is applied to the polymer dispersed liquid crystal 100, an incident light L1 passing through the polymer dispersed liquid crystal 100 will not be affected by the polymer dispersed liquid crystal 100 and will become a transmitting light L2 since the parallel axis refraction ratio n₂ of the liquid crystal molecules is similar to the refraction ratio n₁ of the polymer material 111. Oppositely, when there is no voltage applied to the polymer dispersed liquid crystal 100 (as shown in FIG. 1), the liquid crystal molecules 120 disposed in each liquid crystal encapsulator will be randomly arranged, so the incident light L1 irradiating toward the polymer dispersed liquid crystal 100 will be scattered to different directions.

However, the most unfavorable point of PDLC is that the driving voltage is too high. For solving this problem, the conventional ways to lower the driving voltage include decreasing the liquid crystal cell gap, and adding conducting particles into the liquid crystal molecules. However, the method of decreasing the liquid crystal cell gap will cause deterioration in contrast ratio and the film thickness will be limited. The method of adding conducting particles might cause the polymer material to be conducting and the manufacturing and the cost of the transparent conductive substance may also be a problem.

### SUMMARY OF THE INVENTION

It is one of the objectives of the present invention to provide a polymer dispersed liquid crystal composition for lowering driving voltage of a polymer dispersed liquid crystal display device and a manufacturing method thereof. By adding non-conducting particles into the polymer dispersed liquid crystal composition, the driving voltage can be lowered and the scattering effect can be enhanced.

To achieve the purposes described above, a preferred embodiment provides a polymer dispersed liquid crystal composition for lowering driving voltage of a polymer dispersed liquid crystal display device. The polymer dispersed liquid crystal composition comprises a polymer material, a plurality of liquid crystal molecules and a plurality of non-conducting particles. The liquid crystal molecules are dispersed in the polymer material, and the liquid crystal molecules are disposed in a plurality of liquid crystal encapsulators formed by the polymer material. The non-conducting particles are dispersed in the polymer material.

To achieve the purposes described above, a preferred embodiment provides a polymer dispersed liquid crystal composition. The polymer dispersed liquid crystal composition comprises a polymer material, a plurality of liquid crystal molecules and a plurality of non-conducting particles. The liquid crystal molecules are dispersed in the polymer material, and the liquid crystal molecules are disposed in a plurality of liquid crystal encapsulators formed by the polymer material. The non-conducting particles are dispersed in the polymer material for lowering driving voltage of a polymer dispersed liquid crystal composition.

To achieve the purposes described above, a preferred embodiment provides a manufacturing method of a polymer dispersed liquid crystal composition for lowering driving voltage of a polymer dispersed liquid crystal display device. The method comprises the following steps. First, a compound material and a plurality of liquid crystal molecules are provided. The compound material comprises a polymerization reactive material and a plurality of non-conducting particles. The compound material and the liquid crystal molecules are then mixed. A polymerization treatment is then performed to polymerize the polymerization reactive material for forming a polymer material, and make the liquid crystal molecules and the non-conducting particles being dispersed in the polymer material. The liquid crystal molecules are disposed in a plurality of liquid crystal encapsulators formed by the polymer material.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a condition of a conventional polymer dispersed liquid crystal when no voltage is applied to the conventional polymer dispersed liquid crystal.

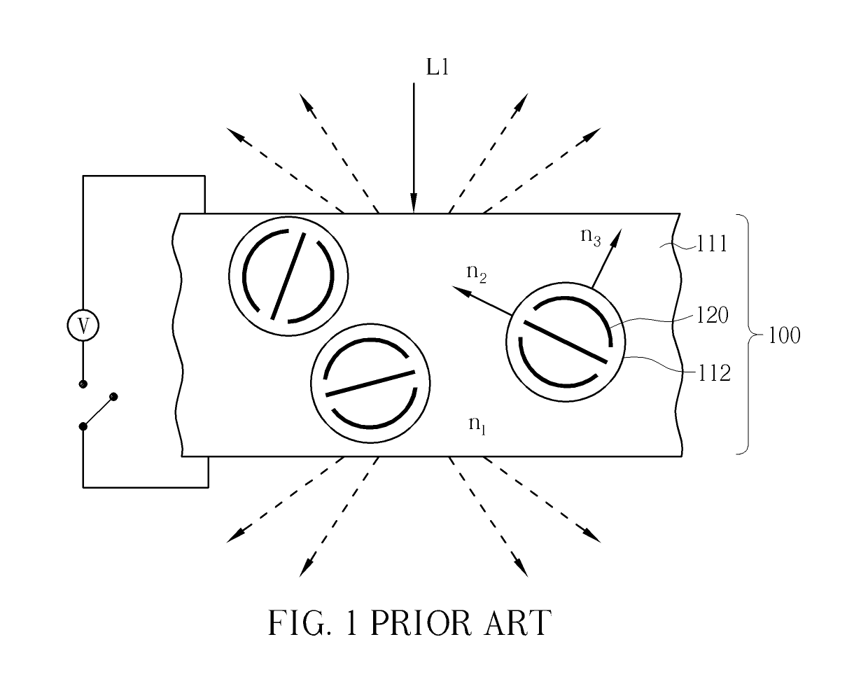

FIG. 2 is a schematic diagram illustrating a condition of the conventional polymer dispersed liquid crystal when voltage is applied to the conventional polymer dispersed liquid crystal.

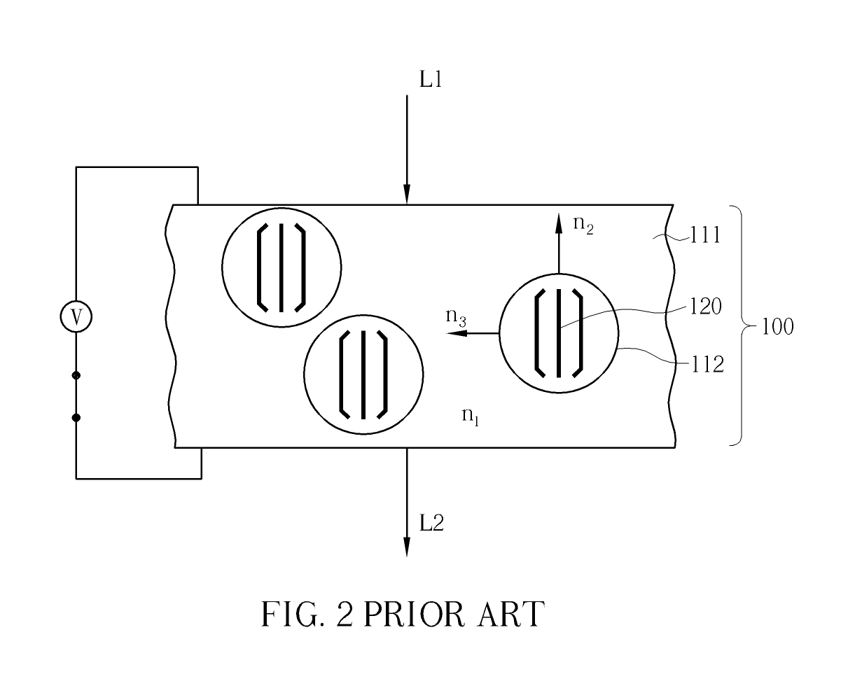

FIG. 3 is a schematic diagram illustrating a polymer dispersed liquid crystal composition according to a preferred embodiment of the present invention.

FIG. 4 is a schematic diagram illustrating a condition of a display device when no voltage is applied to the display device according to a preferred embodiment of the present invention.

FIG. 5 is a schematic diagram illustrating a condition of the display device when voltage is applied to the display device according to the preferred embodiment of the present invention.

FIG. 6 is a flowchart describing a manufacturing method of a polymer dispersed liquid crystal composition according to a preferred embodiment of the present invention.

### DETAILED DESCRIPTION

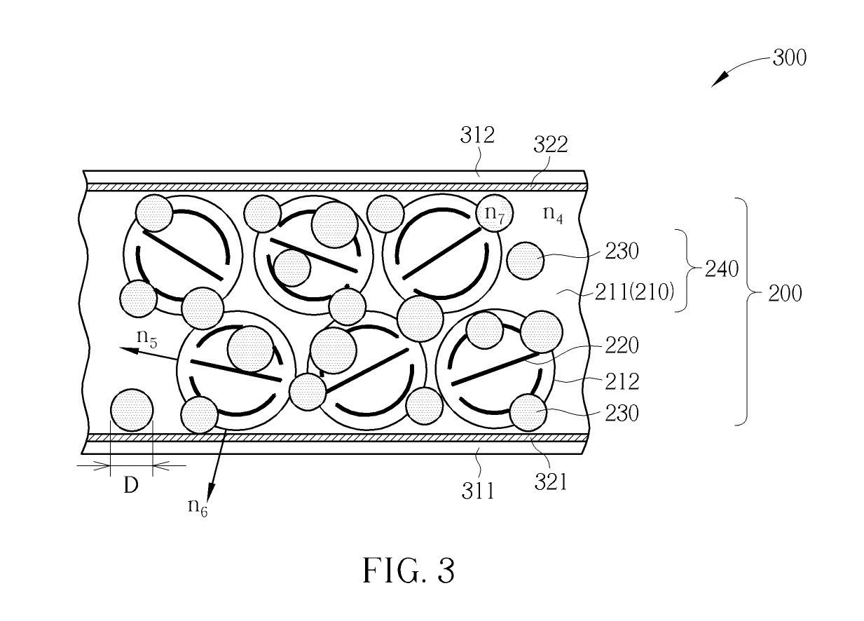

Please refer to FIG. 3. FIG. 3 is a schematic diagram illustrating a polymer dispersed liquid crystal composition for lowering driving voltage of a polymer dispersed liquid crystal display device according to a preferred embodiment of the present invention. Please note that the figures are only for illustration and the figures may not be to scale. The scale may be further modified according to different design considerations. As shown in FIG. 3, a polymer dispersed liquid crystal composition 200 is provided in this embodiment. The polymer dispersed liquid crystal composition 200 comprises a polymer material 211, a plurality of liquid crystal molecules 220, and a plurality of non-conducting particles 230. The liquid crystal molecules 220 are dispersed in the polymer material 211, and the liquid crystal molecules 220 are disposed in a plurality of liquid crystal encapsulators 212 formed by the polymer material 211. The non-conducting particles are dispersed in the polymer material for lowering driving voltage of the polymer dispersed liquid crystal composition 200.

In this embodiment, the non-conducting particles 230 can comprise organic polymer particles or inorganic particles. The material of above mentioned organic polymer particles can comprise polymethyl methacrylate (PMMA), silicone, acrylic glue, foamed polystyrene, or other suitable organic polymer materials. The material of above mentioned inorganic particles can comprise silicon oxide, titanium oxide, zirconium oxide, zinc oxide or other suitable inorganic materials. It is worth noting that the non-conducting particles 230 in this embodiment are preferably polymethyl methacrylate particles, but not limited thereto. A diameter D of each of the non-conducting particles 230 is substantially between 0.3 micrometers and 10 micrometers, and the preferred value is between 1 micrometer and 3 micrometers for a better effect. In addition, the liquid crystal molecules 220 can comprise positive liquid crystal molecules or other suitable liquid crystal molecules. The polymer material 211 can comprise ultraviolet light curing resin (UV glue), thermoplastic resin or other suitable polymer materials. In other words, any material, which may be used to separate phases of the liquid crystal molecules and the polymer material and form the liquid crystal encapsulators, is suitable for this invention. This part belongs to ordinary skill and will not be redundantly described here. It is worth noting that the liquid crystal molecules 220 have a parallel axis refraction ratio n₅ and a vertical axis refraction ratio n₆. The parallel axis refraction ratio n₅ of the liquid crystal molecules 220 is substantially equal to the refraction ratio n₄ of the polymer material 211. When voltage is applied to the polymer dispersed liquid crystal composition 200, the liquid crystal molecules 220 may be arranged in a direction and a presenting refraction ratio of each of the liquid crystal molecules 220 may be similar to the refraction ratio of the polymer material 211, and it helps to present a better transparent condition. Furthermore, the refraction ratio n₄ of the polymer material 211 is preferably substantially equal to a refraction ratio n₇ of each of the non-conducting particles 230 to prevent the preformed transparent condition from being influenced by the non-conducting particles 230. In this invention, numbers of interface which incident light passes through in the polymer dispersed liquid crystal composition 200 may be increased by partially replacing the constituent percentage of the polymer material 211 in the polymer dispersed liquid crystal composition 200 with the non-conducting particles 230. The scattering effect of the polymer dispersed liquid crystal composition 200 when no voltage is applied to the polymer dispersed liquid crystal composition 200 may be accordingly enhanced, and it helps to lower the driving voltage of the polymer dispersed liquid crystal composition 200.

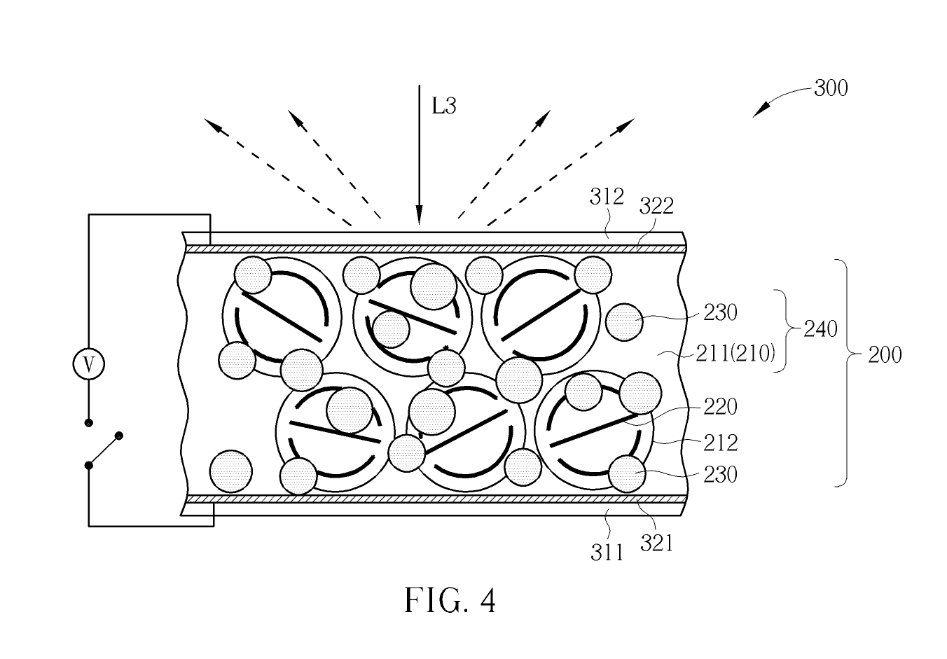

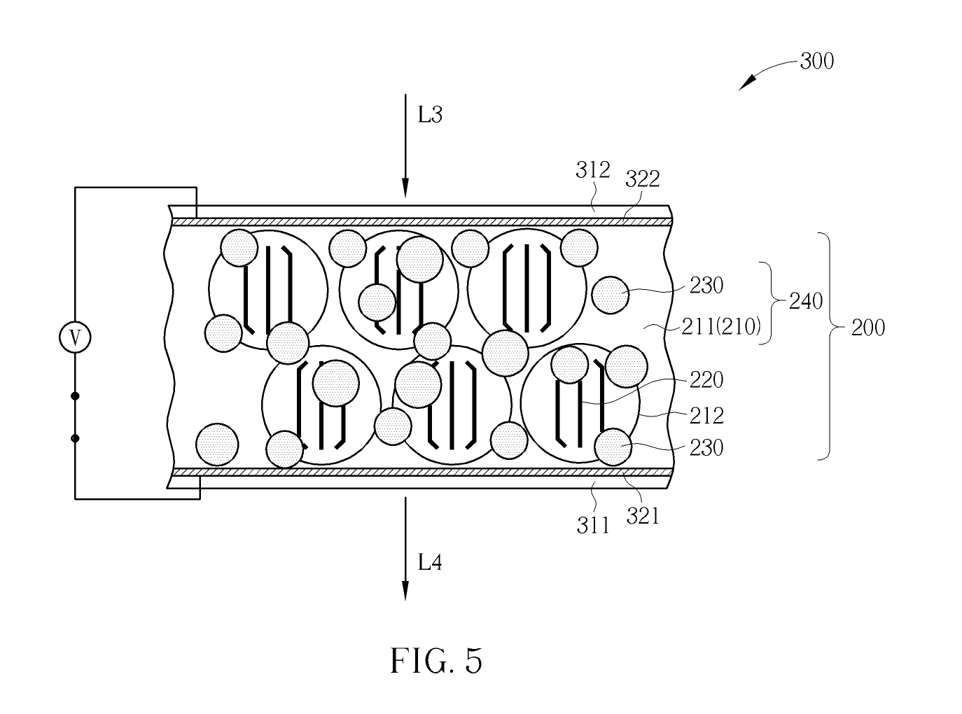

Please refer to FIG. 4 and FIG. 5, and also refer FIG. 3. FIG. 4 and FIG. 5 are schematic diagrams illustrating a display device according to a preferred embodiment of the present invention. As shown in FIGS. 3-5, this embodiment provides a display device 300. The display device 300 comprises an upper electrode 322, a lower electrode 321, an upper substrate 312, a lower substrate 311, and a polymer dispersed liquid crystal composition 200. The lower electrode 321 is disposed oppositely to the upper electrode 322. The lower electrode 321 and the upper electrode 322 are respectively disposed on the lower substrate 311 and the upper substrate 312. The polymer dispersed liquid crystal composition 200 is disposed between the upper electrode 322 and the lower electrode 321. The composition and the material characteristic of the polymer dispersed liquid crystal composition 200 in this embodiment are detailed above and will not be redundantly described. It is worth noting that when voltage is applied to the polymer dispersed liquid crystal composition 200 through the upper electrode 322 and the lower electrode 321 (as shown in FIG. 5), the liquid crystal molecules 220 disposed in each liquid crystal encapsulator 212 are substantially arranged in a vertical direction, and an incident light L3 irradiating toward the display device 300 can pass through the polymer dispersed liquid crystal composition 200 to become a transmitting light L4. Oppositely, when there is no voltage applied to the polymer dispersed liquid crystal composition 200 (as shown in FIG. 4), the liquid crystal molecules 220 disposed in each of the liquid crystal encapsulators 212 will be randomly arranged, so the incident light L3 irradiating toward the display device 300 will be scattered to different directions. In other words, a transparent display effect and a scattering display effect in the display device 300 can be achieved by controlling the state of the liquid crystal molecules 220 in the polymer dispersed liquid crystal composition 200. Moreover, in other preferred embodiments, a color filter can be disposed in the display device 300 or a dyeing material can be added into the polymer dispersed liquid crystal composition 200 to achieve color display effect, but not limited thereto.

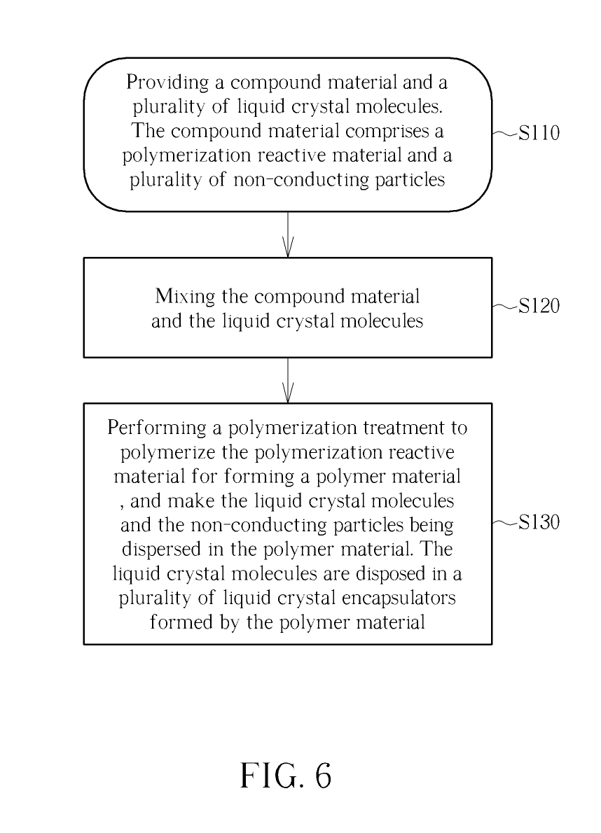

Please refer to FIG. 6, and also refer to FIG. 3. FIG. 6 is a flowchart describing a manufacturing method of a polymer dispersed liquid crystal composition according to a preferred embodiment of the present invention. As shown in FIG. 3 and FIG. 6, a manufacturing method of a polymer dispersed liquid crystal composition 200 is provided in this embodiment. The manufacturing method comprises the following steps. First, in step S110, a compound material 240 and a plurality of liquid crystal molecules 220 are provided. The compound material 240 comprises a polymerization reactive material 210 and a plurality of non-conducting particles 230. Next, in step S120, the compound material 240 and the liquid crystal molecules 220 are mixed. Then, in step S130, a polymerization treatment is performed to polymerize the polymerization reactive material 210 for forming a polymer material 211, and make the liquid crystal molecules 220 and the non-conducting particles 230 being dispersed in the polymer material 211. The liquid crystal molecules 220 are disposed in a plurality of liquid crystal encapsulators 212 formed by the polymer material 211. The composition and the material characteristic of the polymer dispersed liquid crystal composition 200 in this embodiment are detailed above and will not be redundantly described. It is worth noting that the polymerization treatment in this embodiment preferably comprises polymerization induced phase separation (PIPS), temperature induced phase separation (TIPS), solvent induced phase separation (SIPS), or other suitable methods. In addition, the polymerization reactive material 210 in this embodiment may preferably comprise a monomer material (not shown) and a photo initiator (not shown). The above mentioned monomer material may preferably comprise an UV glue monomer or other suitable monomer material for polymerization. The above mentioned photo initiator is used to initiate a polymerization reaction of the monomer material. It is worth noting that the polymerization reactive material 210 is replaced by the non-conducting particles 230 in this invention, and a percentage of the polymerization reactive material 210 in the polymer dispersed liquid crystal composition 200 and a percentage of the photo initiator in the polymer dispersed liquid crystal composition 200 may be accordingly reduced. The negative effect such as a flicker problem which may be caused by residual ions of the photo initiator can be accordingly improved.

TABLE 1

| | | Polymer- | | | |
|---|---|---|---|---|---|
| | Liquid | ization | Non- | Replace- | |
| | crystal | reactive | conducting | ment | Driving |
| | molecule | material | particles | ratio | voltage |
| | (wt %) | (wt %) | (wt %) | (%) | (V) |
| First | 70 | 30 | 0 | 0 | can not |
| compared | | | | | drive |
| example | | | | | |
| First | 70 | 20 | 10 | 33 | 20 |
| embodiment | | | | | |
| Second | 70 | 15 | 15 | 50 | 12 |
| embodiment | | | | | |
| Third | 70 | 10 | 20 | 67 | 6 |
| embodiment | | | | | |
| Second | 70 | 0 | 30 | 100 | can not |
| compared | | | | | drive |
| example | | | | | |

In order to further explain the improvement of the driving voltage of the polymer dispersed liquid crystal composition according to the percentage of the non-conducting particles in the polymer dispersed liquid crystal composition, please refer to Table 1. The driving voltages of the polymer dispersed liquid crystal composition according to the variation of the percentage of the polymerization reactive material (an UV glue monomer in this embodiment) in the polymer dispersed liquid crystal composition and the percentage of the non-conducting particles (a PMMA in this embodiment) in the polymer dispersed liquid crystal composition are listed in Table 1. As shown in Table 1, the percentages of the polymerization reactive material and the non-conducting particles are variant while the percentages of the liquid crystal molecules are kept in a fixed value (70 wt %) in the first compared example, the second compared example, the first embodiment, the second embodiment and the third embodiment. There are only the polymerization reactive material which occupies 30% in the first compared example and only the non-conducting particles which occupy 30% in the second compared example respectively. Therefore, the polymer dispersed liquid crystal compositions in the first compared example and the second compared example can not be driven even the applied voltage is up to 30 volts. However, as the percentages of the non-conducting particles gradually increase from the first embodiment to the third embodiment, i.e., as the replacement ratios of polymer material replaced by the non-conducting particles increase, the driving voltage of the polymer dispersed liquid crystal composition may become lowered gradually. In fact, not only the percentages of the non-conducting particles shown in Table 1 can have this effect, but the driving voltage of the polymer dispersed liquid crystal composition may be lowered as long as the polymer material is partially replaced by the non-conducting particles. In this embodiment, the percentage of the non-conducting particles in the polymer dispersed liquid crystal composition is substantially between 1% and 30%, and the percentage is preferably between 10% and 20%. The replacement ratio of the polymerization reactive material replaced by the non-conducting particles is preferably between 33% and 67%. In other words, the percentage of the non-conducting particles in the compound material is between 33% and 67%, but not limited thereto. In addition, the percentage of the polymer material in the polymer dispersed liquid crystal composition is substantially between 10% and 30%, and the percentage of the liquid crystal molecules in the polymer dispersed liquid crystal composition is substantially between 70% and 90%, but not limited thereto. It is worth noting that the percentages in Table 1 can be adjusted regarding what kinds of liquid crystal molecules, what kinds of the polymerization reactive material and what kinds of the polymerization methods (such as above mentioned PIPS, TIPS, or SIPS) adopted. For example, in general polymerization induced phase separation, the percentage of the liquid crystal molecules is often between 60% and 90%, and the percentage of the polymerization reactive material (such as UV glue) is between 10% and 40%. Under this condition, the driving voltage may also be lowered by replacing the polymerization reactive material with the non-conducting particles, and the trend is that the driving voltage may become lowered more obviously with a higher replacement ratio of the polymerization reactive material replaced by the non-conducting particles. So, this invention is not limited by the data in Table 1, and it is only used to explain the effect of lowering the driving voltage. Furthermore, a diameter of each of the non-conducting particles is substantially between 0.3 micrometers and 10 micrometers, and the diameter of each of the non-conducting particles is preferably between 1 micrometer and 3 micrometers for a better effect. The refraction ratio of the polymer material is preferably substantially equal to the refraction ratio of each of the non-conducting particles so as to prevent the preformed transparent condition from being influenced by the non-conducting particles.

To summarize the above descriptions, the polymer dispersed liquid crystal composition in this invention is formed by partially replacing the compound material in the polymer dispersed liquid crystal composition with the non-conducting particles. The driving voltage of polymer dispersed liquid crystal composition may be lowered as the percentage of the polymer material in the polymer dispersed liquid crystal composition decreases. Additionally, the numbers of the interface which the incident light path passes through in the polymer dispersed liquid crystal composition may be increased to improve the scattering effect when no voltage is applied to the polymer dispersed liquid crystal composition. The objectives of lowering the driving voltage and improving the scattering effect can be achieved simultaneously by the polymer dispersed liquid crystal composition of this invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A polymer dispersed liquid crystal (PDLC) composition for lowering driving voltage of a polymer dispersed liquid crystal display device, the polymer dispersed liquid crystal composition comprising:
a polymer material;
a plurality of liquid crystal molecules, dispersed in the polymer material, wherein the liquid crystal molecules are disposed in a plurality of liquid crystal encapsulators formed by the polymer material; and
a plurality of non-conducting particles, dispersed in the polymer material.

2. The polymer dispersed liquid crystal composition of claim 1, wherein a percentage of the non-conducting particles in the polymer dispersed liquid crystal composition is substantially between 1% and 30%, a percentage of the polymer material in the polymer dispersed liquid crystal composition is substantially between 10% and 30%, and a percentage of the liquid crystal molecules in the polymer dispersed liquid crystal composition is substantially between 70% and 90%.

3. The polymer dispersed liquid crystal composition of claim 1, wherein a diameter of each of the non-conducting particles is substantially between 0.3 micrometers and 10 micrometers.

4. A polymer dispersed liquid crystal (PDLC) composition, comprising:
a polymer material;
a plurality of liquid crystal molecules, dispersed in the polymer material, wherein the liquid crystal molecules are inside a plurality of liquid crystal encapsulators formed by the polymer material; and
a plurality of non-conducting particles, dispersed in the polymer material, wherein the non-conducting particles are used to lower driving voltage of the polymer dispersed liquid crystal composition.

5. The polymer dispersed liquid crystal composition of claim 4, wherein a percentage of the non-conducting particles in the polymer dispersed liquid crystal composition is substantially between 1% and 30%, a percentage of the polymer material in the polymer dispersed liquid crystal composition is substantially between 10% and 30%, and a percentage of the liquid crystal molecules in the polymer dispersed liquid crystal composition is substantially between 70% and 90%.

6. The polymer dispersed liquid crystal composition of claim 4, wherein a diameter of each of the non-conducting particles is substantially between 0.3 micrometers and 10 micrometers.

7. A manufacturing method of a polymer dispersed liquid crystal (PDLC) composition for lowering driving voltage of a polymer dispersed liquid crystal display device, comprising:
providing a compound material and a plurality of liquid crystal molecules, wherein the compound material comprises a polymerization reactive material and a plurality of non-conducting particles;
mixing the compound material and the liquid crystal molecules; and
performing a polymerization treatment to polymerize the polymerization reactive material for forming a polymer material and make the liquid crystal molecules and the non-conducting particles being dispersed in the polymer material, wherein the liquid crystal molecules are disposed in a plurality of liquid crystal encapsulators formed by the polymer material.

8. The manufacturing method of the polymer dispersed liquid crystal composition for lowering the driving voltage of the polymer dispersed liquid crystal display device of claim 7, wherein a percentage of the non-conducting particles in the compound material is between 33% and 67%.

9. The manufacturing method of the polymer dispersed liquid crystal composition for lowering the driving voltage of the polymer dispersed liquid crystal display device of claim 7, wherein a percentage of the non-conducting particles in the polymer dispersed liquid crystal composition is substantially between 1% and 30%, a percentage of the polymer material in the polymer dispersed liquid crystal composition is substantially between 10% and 30%, and a percentage of the liquid crystal molecules in the polymer dispersed liquid crystal composition is substantially between 70% and 90%.

10. The manufacturing method of the polymer dispersed liquid crystal composition for lowering the driving voltage of the polymer dispersed liquid crystal display device of claim 7, wherein a diameter of each of the non-conducting particles is substantially between 0.3 micrometers and 10 micrometers.
